(19) United States
(12) Patent Application Publication
(10) Pub. No.: US 2013/0198101 A1
(43) Pub. Date: Aug. 1, 2013

(54) METHOD FOR OPERATING AUTOMATIC STORAGE SYSTEMS FOR DISTRIBUTING OBJECTS TO A PLURALITY OF PERSONS, AND AUTOMATIC STORAGE SYSTEM DESIGNED IN A CORRESPONDING MANNER

(71) Applicants: Guenther Beckerle, Linz (AT); Christian Hummer, Wilhering (AT)

(72) Inventors: Guenther Beckerle, Linz (AT); Christian Hummer, Wilhering (AT)

(73) Assignee: KEBA AG, Linz (AT)

(21) Appl. No.: 13/821,340

(22) PCT Filed: Sep. 14, 2011
(86) PCT No.: PCT/AT2011/000375

§ 371 Date: Apr. 8, 2013

(30) Foreign Application Priority Data
Sep. 14, 2010 (AT) A 1527/2010

(51) Int. Cl. G06Q 50/10

(52) U.S. Cl. CPC G06Q 50/10
USPC 705/330

(57) ABSTRACT

The invention relates to a method for operating automatic storage systems (1) for distributing objects to a plurality of persons. Each object to be distributed and to be transferred to authorized persons is stored by at least one authorized deliverer in a receiving compartment (3, 3′, 3″) of an automatic storage system (1) compartment arrangement (4) that consists of multiple receiving compartments (3, 3′, 3″). The objects are then released by a control system (6) to authorized persons for removal dependent on use or access rights to the respective object or to the respective receiving compartment (3, 3′, 3″). At least one evaluating system is used in the control system (6) with respect to an ergonomic and/or person-specific reachability or accessibility of the individual receiving compartments (3, 3′, 3″) of the compartment arrangement (4). The control system (6) is designed such that persons who are authorized to retrieve objects can arrange a preferred or a mandatory storage of objects in storage compartments (3, 3′, 3″) with a specified reachability, and the persons can register such an arrangement in a database (25) that can be accessed by the control system (6). Such a registration or request is carried out by an authorized receiver or retriever of objects via an internet portal (40).

The invention relates to a method for operating automatic storage/systems for distributing objects, in particular goods or postal items, to a plurality of persons, as well as a suitably designed automatic storage system, as described in the preambles of claims 1 and 24.

Many different embodiments are known of automatic storage systems in the form of vending machines. In this case various goods offered for sale are stored in a stack or in individual compartments of the automatic storage system. An essentially unrestricted range of people can make a selection from the fixed predefined selection of products and on the payment of a fee, in particular on payment of the appropriate purchase price, can buy the selected item and remove it from the vending machine. The person operating these kinds of vending machines generally does not know the respective group of people or purchasers, as it involves the anonymous purchase or anonymous collection of the goods offered for sale. An exemplary embodiment of such a vending machine is disclosed for example in EP 0 749 101 A2. These kinds of vending machines are set up as “Stand-Alone-Units” and do not have any data connection or communication interfaces for the remote transmission of data or information.

A vending machine or vending system with a data connection communication interface is known for example from DE 41 30 033 A1. In the latter a vending system is proposed in which a unit with a predefined number of compartments is arranged in a room, said compartments each having a door that can be locked by a locking device. At least one terminal is arranged at a distance from this room and is connected via cable to a computer unit. The terminal remote from the compartment unit comprises a display device. On the acceptance of an order a trader of goods enters information about the compartment occupancy to the assigned terminal. The computer unit then displays on the display device which compartment has been reserved for storing the ordered goods, or alternatively shows that none of the compartments is available for storing the ordered goods. In this way in the time between the customer ordering the goods from a trader and the time of filling a compartment with these goods not all of the free compartments are occupied by other traders. Furthermore, it is achieved in this way that if all of the free compartments are already occupied at the time of the order, it is displayed to the trader that there is no free compartment available so that he can inform the customer accordingly.

DE 41 34 410 A1 also describes a vending system in which a unit with a predefined number of compartments is located in a room, said compartments each having a door that can be locked by a locking device. The compartment unit is provided with a computer unit to which a sales device is assigned which has at least one memory device, in which text and/or image information can be saved about goods offered in specific compartments. Compartment numhers of the compartments containing the corresponding goods as well as the prices of these goods can be allocated to the text and/or image information. An offer number assigned to text and/or image information and information for identifying a customer can be communicated to the sales device via an input device for reserving a compartment. In this way in the evening or when the store closes a trader can fill the unreserved compartments with goods and customers are able to choose items from the filled compartments after the store has closed. In this way the use of the compartments and the economic efficiency of the system can be improved for the operator of the automatic system.

WO 2005/111954 A1 and WO 2006/032067 A1, which are also in the name of the Applicant, describe automatic storage systems for objects, which automatic storage systems each comprise a compartment arrangement having a plurality of compartments. According to a first embodiment such an automatic storage system comprises a central, predefined access opening into the automatic housing to enable or deny access to a specific, individual compartment or to a specific group of adjacent compartments. In this case various different safety systems have been proposed in order to achieve broad, increased personal safety and prevent any risk to persons caused by the automatic running of the machine or from the automatically activated movement drives.

WO 01/31827 A2 describes a system and a method for the temporally disconnected transfer of objects between a distributor or deliverer of objects and various different recipients of individually assigned objects. In this case an automatic storage system is selected from a plurality of networked automatic storage systems, said selection being made for example according to a place of residence or details about the known recipient. The relevant deliverer transports and then transfers the respective object at any time to the selected automatic storage system. The object to be delivered is identified in the automatic storage system and also the intended recipient or addressee is recorded in a database. The object to be transferred is then recorded temporarily at a point in the automatic storage system known to the control system of the automatic storage system. Then the recipient receives a request to remove the deposited object from the automatic storage system. The automatic storage system then checks whether a previously deposited object ready for collection can be transferred to a specific retriever and releases the object to the respective recipient or collector after a positive verification. A system of this kind is suitable for transferring items, in particular postal items or other goods, between a delivery organization and a plurality of persons, who receive postal items either regularly or only sporadically. The temporal disconnection which can be achieved by means of this delivery and collection system between the delivery process and the collection process is advantageous in many cases for the recipient of items. However, the corresponding distribution system is only satisfactory for a limited group of people.

DE 44 43 018 A1 describes a method for ordering goods, in which in a means of transport, such as for example an aircraft, ship or train, a sales device, a selection device and a transmission device are provided. By means of the selection device and the sales device goods can be offered to a purchaser and selected by the latter as required. The relevant information about the goods is sent together with a buyer identification and information about the desired travel destination site of the buyer to the transmission device and is sent by the latter via a data transfer path to a central receiving device. The central receiving device is connected via additional data transfer paths with a plurality of filling and collection stations to various possible travel destinations. The filling and collection stations each comprise a goods store and at least one output device where the buyer can collect the goods selected via the selection device after his identification at the travel destination. In this way a buyer is able to use the time available to him when using a means of transport for ordering goods and can use the goods in a place that is remote from the point of delivery and ordering of the goods, the area of residence of the buyer not important being important here.

US 2003/0025590 A1 describes a data-technically networked system with a plurality of locally distributed automatic storage systems, which automatic storage systems each comprise a plurality of receiving compartments. This system allows an unrestricted group of purchasers to order goods online from a selected provider and enables the delivery of the ordered goods to an automatic storage system defined by the purchaser. The purchaser is then informed about the delivery of the ordered item and can collect it at a preselected time. When the purchaser is making the order the purchaser can inform the provider of special criteria, such as for example the desired compartment size for the ordered goods, refrigeration for perishable goods, or the maximum height of the receiving compartment in order to account for physically disabled people. The control system then searches for a suitable, available receiving compartment in the automatic storage system at the desired location. Once the order is complete the provider sends corresponding delivery instructions to a delivery company, and these instructions are preferably placed directly on the parcel. The disadvantage here is that the delivery company or the deliverer of the goods and also the provider of goods are given personal information about the purchaser.

The objective of the present invention is to create a method for operating automatic storage systems for distributing objects, in particular goods or postal items, which will facilitate the use of a transfer and delivery system for objects with a time delay between the transfer and delivery process for the largest possible group of people or users. In particular, information about personal disabilities should only be accessible to a defined or authorized group of people. A further objective of the invention is to provide a corresponding automatic storage system.

This objective is achieved by a method according to the features described in claim 1. In this way a temporally disconnected delivery and collection process for objects, in particular goods or postal items is made possible or can be processed, without the deliverer of the corresponding object and the respective authorized receiver having to be at the same place at the same time. In particular, by integrating automatic storage systems into the delivery and collection process an authorized deliverer can safely store the relevant objects in a selected automatic storage system at a time desired by him and that can be determined relatively freely and then an authorized collector or retriever of the respective object can pick up or collect the temporarily deposited object at time desired by him that can be determined relatively freely. The technical components of the automatic storage system or the whole system which comprises a plurality of networked automatic storage systems has considerable economic, environmental and customer-specific advantages, mainly relating to the delivery or transfer of postal items, such as for example parcels, or letters. An essential aspect of the method according to the invention is that it is possible in this way for a comparatively large group of people to use the corresponding delivery and collection system and to use it in relative comfort. In particular, physically disabled people are also provided with good access or relatively easy accessibility to the respectively store and temporarily deposited object. In this way there is no disadvantage for physically disabled people, in particular people with physiologically impaired movement, for example because of being of small stature, being physical weak or needing walking or driving aids, such as for example a wheel chair. This means that people, in particular collectors, with various different disabilities or physical impairments can use and participate in the correspondingly run distribution systems for objects or postal items without any restrictions. The disadvantages of physically disabled people can be eliminated as far as possible by the measures according to the invention. In particular, it is possible to achieve in this way that a person with physical disabilities, in particular with impaired movement is not dependent on outside help or only in exceptional circumstances, when the person in question picks up or collects an object ready for collection from the respective compartment of an automatic storage system. Similarly, the operating method according to the invention if necessary can also take into account people or provide improved services to those people who require more comfortable access to the distribution system. In particular, it is possible by means of the measures according to the invention in an advantageous manner to take into account a person or a group of people who want good accessibility or as far as possible easy reachability to stored objects for reasons of comfort or increased comfort requirements. Thus by means of the operating method according to the invention these kinds of accessibility requirements can be addressed individually. Furthermore, by means of the described measures of the method for operating automatic storage systems for the distribution of objects the corresponding distribution system can be made available to a much greater group of people, whereby the economic efficiency of such a system can be increased for the operator. In addition, in this way the acceptance or the frequency of use of a distribution system operating according to the method of the invention is increased significantly. Furthermore, it is possible to meet the requirements in communal structures for the barrier-free configuration of publicly accessible installations. Lastly, economic and user-specific advantages can be achieved both for the operator of the system and also for the customer or user of the system.

In the configuration according to the invention it is particularly advantageous that the control system can save and prioritize which recipients or collectors of objects have requested a special status or a prioritized compartment allocation. If the respective user or collector saves a corresponding status in a remotely accessible database of the control systems this becomes the basis for generating corresponding control instructions and control sequences and in this way a high degree of availability and system reliability can be guaranteed. Mainly because the respective specifications or settings are saved in a central database, which settings can be recorded and/or changed by way of an internet portal, the user friendliness or service friendliness of the corresponding databases or control sequences that can be achieved is almost optimal. In particular, if the authorized recipient or collector of objects directly updates the relevant information the requirements for data protection specifications can also be take into account in a simple and technically reliable manner. In addition, user comfort can be increased and the probability of errors can also be reduced.

Furthermore, the measures according to claim 2 are advantageous, as in this way the allocation of the receiving compartments into different accessibility classes is performed which can be managed relatively easily by data or control technology. In particular, by means of a height classification of the individual receiving compartments of a compartment arrangement any increased comfort requirements and/or any physical disabilities of people can be catered for relatively well. Furthermore, a distribution and collection system of this kind is accessible or of interest to a much larger group of people.

A further advantageous classification of the receiving compartments of the compartment arrangement is described in claim 3. In this way the data and control technology input is relalively small but it is still possible to achieve a relatively optimum or favorable classification or grouping of the respective receiving compartments. In the correspondingly defined height area people who require a greater degree of comfort and people with physical disabilities, for example wheelchair users, or people with leg, back or shoulder problems, are able to collect the designated object and remove it from the respective receiving compartment in relative comfort.

Furthermore, by means of the measures according to claim 4, which can be applied alternatively or in combination with a height classification, various different accessibility classes or at least two areas of different accessibility can be determined. Accordingly, also the horizontal distance of a receiving compartment in relation to a central operating unit or in relation to the user interface of the automatic storage system can be a criterion for good accessibility and for example average or comparatively poor accessibility. Receiving compartments which are relatively remote from the operating unit of an automatic storage system are comparatively disadvantageous for people who have problems walking. This is case in particular if it is necessary to change position several times between the operating unit and the respective receiving compartment.

By way of the measures according to claim 5 it is either ensured or facilitated that a deliverer of objects deposits the respective object into a free receiving compartment of the compartment arrangement which has relatively good accessibility or reachability. The arbitrary filling of the compartments by the deliverer is thus prevented or avoided. A further advantage of these measures is that the corresponding sequences are automated or at least partly automated and thus incorrect operations or unconsidered actions or compartment allocations can be virtually excluded. In this way the service and customer satisfaction of the correspondingly operated distribution and collection system can be increased further.

The measures according to claim 6 are also particularly advantageous as in this way the delivery or depositing process for an authorized deliverer, in particular for an employee of a dispatch or distribution company can be facilitated or accelerated. In this case during a delivery process which requires the prioritized or status-dependent special delivery of an object into a free receiving compartment of the compartment arrangement, a number of free receiving compartments of different sizes in the respective area or accessibility class are released or unlocked automatically by the control system. The deliverer can then select a suitable or corresponding compartment by means of a simple, visual size comparison and store the object to be deposited therein and lock it. It is also prevented in this way that objects with priority with regard to subsequent accessibility or reachability are stored in receiving compartments with the incorrect or unsuitable accessibility class for the collector.

The measures according to claim 7 are also an advantage, as in this way without a fixed compartment allocation or without the pre-reservation of receiving compartments the requirements or wishes of an authorized collector or recipient can be taken into account relatively well.

The measures according to claim 8 are also advantageous, as in this way a largely automatic allocation of compartments or a relatively rapid allocation of receiving compartments with a corresponding accessibility class can be performed. In particular, incorrect operations or incorrect allocations caused by the inattention of a deliverer can be virtually excluded in this way.

It is ensured by the measures according to claim 9 that there is a largely automatic or automatic technically supported allocation of objects or postal items and available, suitable receiving compartments. Depending on possibly defined and allocated or individually assigned access or reading rights or codes of information in the database also special data protection requirements can be taken into account in a simple manner.

The measures according to claim 10 are also an advantage, as in this way the poor utilization of the receiving compartments with comparatively poor accessibility or comparatively uncomfortable accessibility can be opposed in a simple manner. In particular, if a request is made for receiving compartments with relatively good accessibility or easy access and this requirement is made for reasons of ease or comfort, a comfort charge or user fee is added. Accordingly to an advantageous development it is possible to reduce or cancel this usage charge or additional fee by presenting a doctor's note relating to a physical disability. As a rule in this way it is possible to achieve an improved utilization of the holding or compartment capacities of an automatic storage system or a network of automatic storage systems.

The measures according to claim 11 are also particularly advantageous, as in this way a registered user or recipient of items or objects can determine or define as necessary which accessibility classes or receiving compartments should be released or locked for depositing objects or postal items. The respective deliverer can then place the respective objects electively into a free receiving compartment of the corresponding accessibility class. Particularly if a registered recipient in a database, which is accessible for example via an internet portal, can release or lock the various different accessibility classes, a high standard of service is provided which considerably increases the user acceptance of the system. Furthermore, in this way as necessary at any time a change or entry of corresponding requests or requirements can be carried out. In addition, by means of this setup option for the respective group of people or users the problems of delayed registration or incorrect settings are minimized.

The measures according to claim 12 are also an advantage as in this way the users of the distribution or collection system, which also allow the occupation of receiving compartments with relatively poor accessibility or access, can get a benefit provided by the distribution and collection system for example in monetary form or in another form. In this way it is achieved that as many receiving compartments of a compartment arrangement as possible have a good utilization rate. In particular, in this way a more even utilization of all available receiving compartments of a compartment arrangement can be achieved.

The further measures according to claim 13 can also be advantageous as in this way in case of a lack of status information about the user of the distribution and collection system a status relating to a physical disability is accepted automatically for the respective collector or recipient. In this way it is ensured that a collector or recipient, whose status is unknown with regard to possible physical disabilities, is allocated a receiving compartment at the outset from which the object to be removed can be taken out relatively easily or comparatively comfortably. A further, particular advantage of this measure is also that it is possible avoid the generation or collection of data about possible physical disabilities, if only information is stored in the control system or in a corresponding database system about whether a specific user or recipient can reach or use all of the compartments of the compartment arrangement.

The measures according to claim 14 are also advantageous, as in this way failed delivery attempts or delivery journeys can be avoided if no receiving compartment of a suitable accessibility class is available for the respective recipient. In addition to saving time and reducing costs in an advantageous manner there are also advantages relating to the environment, since avoiding unnecessary delivery journeys or delivery attempts can lead to a reduction in CO₂ emissions. In particular, an authorized deliverer can coordinate the delivery process or only start it when it is virtually certain that a receiving compartment of suitable size is available in the corresponding accessibility class.

The measures according to claim 15 are also advantageous, as it is possible in this way for a deliverer or a delivery company to influence both the location or the erection site of an automatic storage system and also to reserve the relevant accessibility classes of receiving compartments in advance. Also in this way unnecessary or unsuccessful delivery journeys are avoided, thereby saving time and money. Furthermore, a reduction in CO₂ emissions can be achieved in this way.

The measures according to claim 16 or 17 are also particularly advantageous. On the one hand the requirements for data protection can be met in this way, as the machine-readable identifier contains the relevant information in coded form, so that there is no need to have any plain text information on the related package or on the object to be transferred. The reading of the relevant information or identifiers can be performed in that for example the deliverer of the object or the relevant item does not receive any information about whether the authorized collector or recipient has a specific status with regard to physical disability. A further advantage of this embodiment is that the corresponding information is also associated with the object or the object to be transferred, so that an extensive, data-technical network is not absolutely necessary. In particular, in this way the object to be delivered or the relevant item is itself the key or the releasing means for allocation into a receiving compartment with specific accessibility.

An advantageous development is described in claim 18. In this way in an advantageous manner the respective recipient or an authorized collector can assess from the message, which is preferably an electronic collection message via SMS or e-mail, whether he can pick up the relevant object, in particular a package, without difficulty, or whether he may need the help of a third party in some circumstances. Consequently, by way of these measures a contribution is made to achieving a collection process that runs as smoothly as possible.

Also the development according to claim 19 is advantageous, as in this way the authorized collector or retriever in case of difficulties picking up objects or articles at the location can request the rearrangement of the corresponding object into a receiving compartment with a different accessibility class via a corresponding internet portal. In this way the user friendliness and the suitability for daily use of the corresponding automatic system is further improved. In addition, such a system can be used as conveniently as possible for a comparatively large number of people. In addition, a system of this kind can provide greater customer friendliness.

Furthermore, a development according to claim 20 is an advantage as in this way opening and unlocking processes can be prevented, if the object in question has to be removed from a disadvantageous point of the compartment arrangement for the collector or recipient. This means that before the unlocking or before granting access to the respective object a rearrangement can be requested by the collector and it is possible to request a rearrangement into a receiving compartment with a different accessibility class or better accessibility. This request is entered directly into the control system of the automatic network or the automatic storage system, so that an access-authorized deliverer during a subsequent or upcoming delivery process can carry out the relevant rearrangement into a different receiving compartment.

Lastly, a development according to claim 21 is advantageous, as in this way an authorized recipient or collector of objects can decide individually and spontaneously whether he requires the deposit of the object in a receiving compartment with specific accessibility or reachability or desires this for any reason for the impending delivery or storage of an object into an automatic storage system. In this way the flexibility of the system and the satisfaction or acceptance for users of the system can be increased further. This development can be implemented inexpensively but particularly effectively for example particularly advantageously on the basis of frequently available tracking systems (track and trace) of different delivery and parcel services.

The measures according to claim 22 and/or 23 are also advantageous, as in this way better consideration can be given to the protection of personal or intimate data, mainly relating to physical disabilities.

Furthermore, the objective of the invention is achieved by means of an automatic storage system according to claim 24. The technical effects and advantages achievable thereby can be taken from the preceding parts of the description.

For a better understanding of the invention the latter is explained in more detail with reference to the following Figures.

In a much simplified, schematic representation:

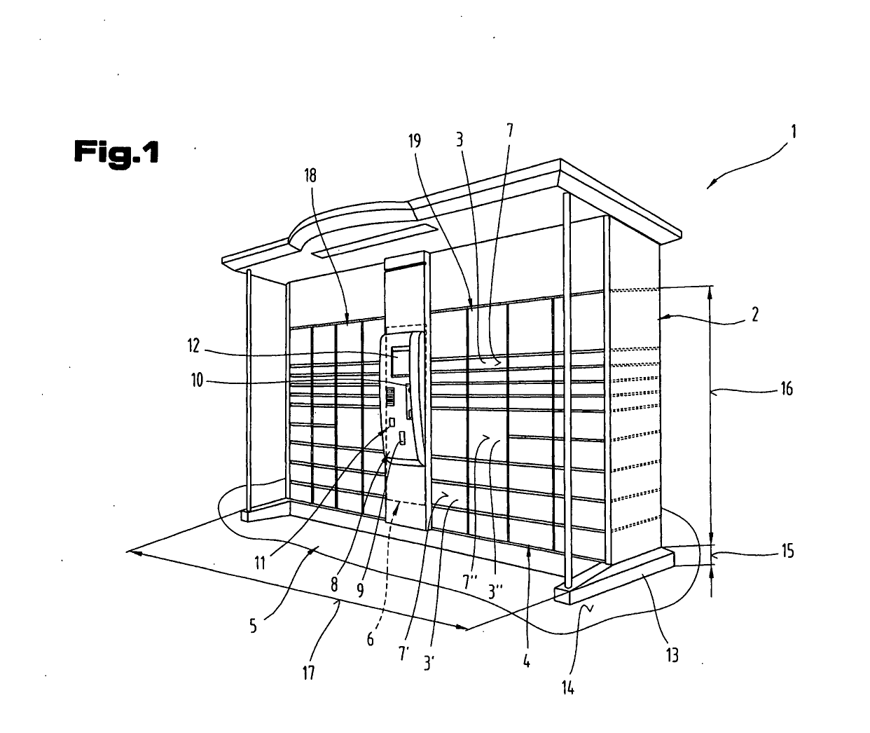

FIG. 1 shows an exemplary embodiment of an automatic storage system, which can be operated according to the invention;

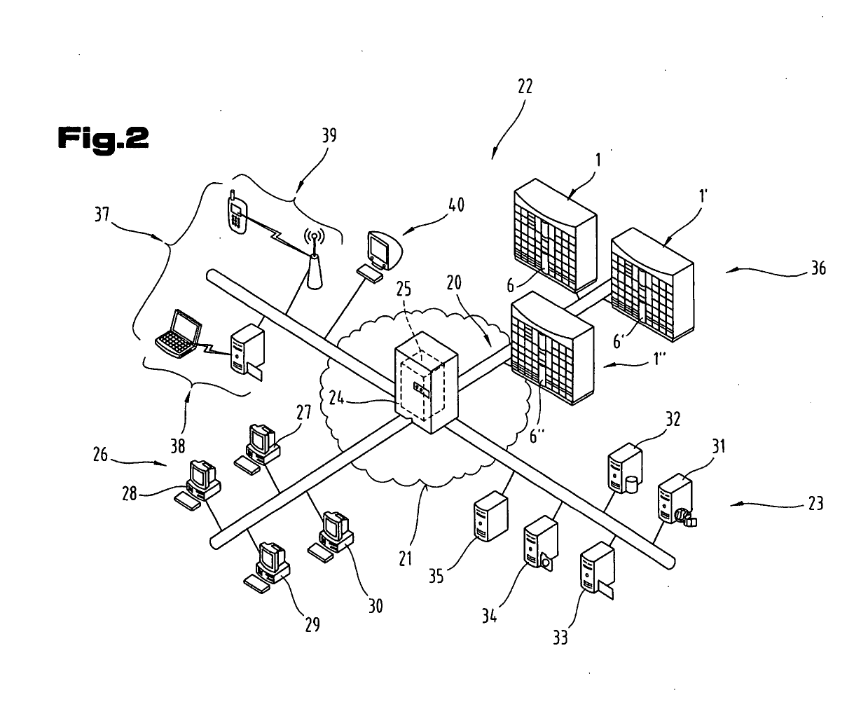

FIG. 2 shows an exemplary embodiment for the technical data networking of a plurality of automatic storage systems;

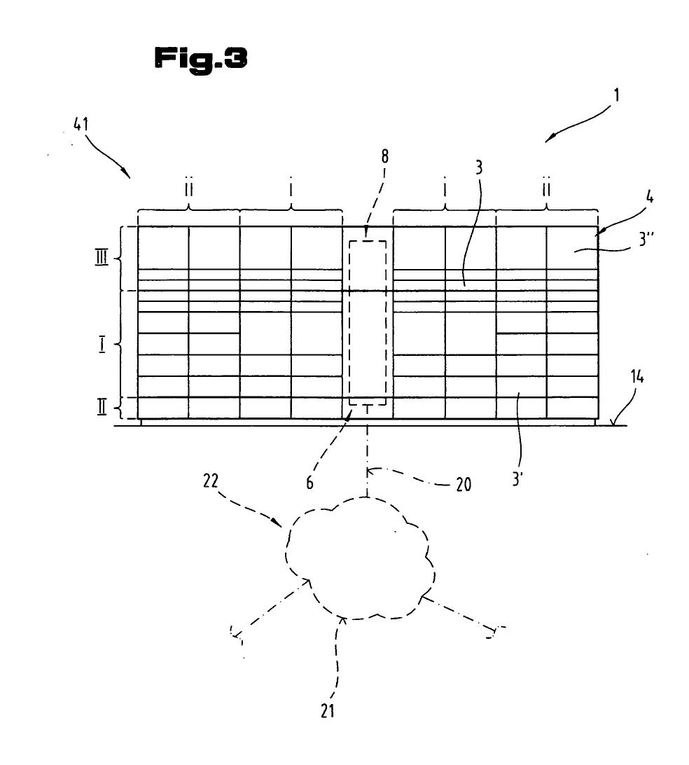

FIG. 3 shows an exemplary plan for evaluating the accessibility or reachability of the receiving compartments of an automatic storage system.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

FIG. 1 shows an exemplary embodiment of an automatic storage system 1, which can be operated or controlled according to the invention. An electromechanical automatic storage system 1 for various different objects or items is preferably used as a parcel depot or as a parcel delivery machine for the postal or delivery service. If necessary an automatic storage system 1 of this kind can also be configured as a vending machine for goods or as a luggage storage machine at railway stations or airports. An automatic storage system 1 of this kind can however also be adapted for renting or hiring various different types of objects, such as for example tools, or can be used as a transfer station for various different services, for example clothes cleaning, photograph printing, repairs and the like. However, it can also be used as a clothes storage device, for example in swimming pools or fitness centers.

In particular, such an automatic storage system 1 can be used to provide temporary, secure storage for objects or for transferring objects between different people with a time delay at the transfer site, i.e. the corresponding automatic storage system 1. If necessary, such an automatic storage system 1 can also be used to hand over or deliver objects without sales staff being directly involved.

The automatic storage system 1 comprises a housing 2 which is sufficiently secure from unauthorized access or various types of vandalism 2, which housing essentially represents the external delimitation of the machine. The housing 2 which is sufficiently secure from break-in provides a mechanical access protection to the objects stored in the machine. Part sections of the machine housing 2 can also be formed by a different type of external delimitation, for example by a wall or the like, and can thus protect the respective objects from unauthorized access.

The machine housing 2 surrounds at least in sections a plurality of receiving compartments 3, 3′, 3″, which are provided for the temporary deposit of a plurality of objects or goods. The receiving compartments 3, 3′, 3″ can be arranged—as shown schematically—in a field-like or matrix-like manner or can also be structured in the form of a carousel or magazine. This means that inside the machine housing 2 a matrix or field-like or round magazine-like compartment arrangement 4 can be formed with a plurality of individual receiving compartments 3, 3′, 3″ which are accessible and lockable from at least one side. Preferably, the receiving compartments 3, 3′, 3″ of the compartment arrangement 4 are formed in at least two different sizes in order to store post of different sizes, such as for example parcels or other objects. In the shown exemplary embodiment three compartment sizes are provided. In particular, small receiving compartments 3, medium-sized receiving compartments 3′ and large receiving compartments 3″ are formed, whereby a practical embodiment is created which in most cases is suitable for accommodating an average item or parcel.

The individual receiving compartments 3, 3′, 3″ preferably of different sizes, in particular different heights and/or widths, can if necessary comprise special devices for the storage of specific objects, such as for example holding devices, holding cups, compartment dividers or the like. The receiving compartments 3, 3′, 3″ can however also comprise devices for providing specific storage conditions, such as for example heating devices, cooling devices, humidity regulators, lighting devices, movements devices, devices for producing a protective atmosphere or for ensuring sterility and the like or can be connected to such devices.

In order to regulate automatically access to individual or specific receiving compartments 3, 3′, 3″ of the compartment arrangement 4, the automatic storage system 1 comprises at least one access control device 5. Said access control device 5 comprises mechanical, electromechanical and electrotechnical components. Typically, this kind of access control device 5 comprises at least one electronic control system 6, at least one locking and/or unlocking device controlled by the control system 6 and at least one locking device, for example a plurality of compartment doors 7, 7′, 7″, which can be locked or unlocked selectively by means of the locking and/or unlocking device as a function of the control commands of the control system 6. In particular, by means of the control system 6, which can be a decentral part component of a distributed communication or control system 6—FIG. 2—, the access rights to the respective receiving compartments 3, 3′, 3″ of the compartment arrangement 4 can be managed. For this any constructions and control sequences known from the prior art can be used.

The access control device 5 can also comprise parts of a user interface 8 of the automatic storage system 1. An effective user interface 8 comprises at least one input device and at least one output device for interaction with the automatic storage system 1 or for influencing the method or control sequences of the control system 6. According to an advantageous embodiment an optoelectronic scanning device 9 and at least one input keyboard 10, in particular a keypad, is provided as the data or control technical input device. The optoelectronic scanning device 9 is preferably formed by a rotational scanner unit, for example to read barcodes on objects to be stored, authorization proof or tickets or collection cards. As an additional input device if necessary a reading device 11 can be provided for data carriers known from the prior art, such as for example magnetic and/or chip cards and/or for transponders or RFID tags. The data entered or detected by the respective input device is processed in the control system 6 and evaluated or stored and used to influence the sequences in the control system 6 or in the area of the automatic storage system 1. As the output device, as already known, at least one display 12 can be provided, by means of which relevant information can be output visually. According to an advantageous embodiment the display 12 can be configured as a touch screen in order to create a combined input and output device. Additional, not shown output devices can be defined for example by acoustic output devices, such as for example loudspeakers or buzzers.

It is essential that the respective input and output devices of the automatic storage system 1, which essentially form its user interface 8, enable sufficient interaction with the automatic storage system 1 or with the automatic system—FIG. 2—and guide the user quickly, correctly and intuitively to the available functions and influencing measures of the automatic storage system 1. In this respect a plurality of operating and control concepts are known in the name of the Applicant.

The basic structure of the corresponding automatic storage systems 1 comprises as a rule a magazine with a rigid, matrix-like arrangement with receiving compartments 3, 3′, 3″ separated by solid dividing walls. In order to obtain the largest possible usable space for the simultaneous storage of as many postal items or objects as possible relative to the required storage area, the receiving compartments 3, 3′, 3″ and their access openings are distributed over a relatively large vertical and/or horizontal area of the automatic storage system 1. In particular however, accessibility or reachability for people with various physical requirements varies owing to the vertical but also the horizontal installation position of the respective receiving compartments 3, 3′, 3″.

A generic automatic storage system 1 comprises typically more than 20 receiving compartments 3, 3′, 3″, in particular up to 100 receiving compartments, usually about 60 receiving compartments 3, 3′, 3″, which receiving compartments 3, 3′, 3″ can be filled randomly with objects or postal items to be transferred which are then picked up latter by an authorized collector or retriever. This means that there is typically no long-term or permanent allocation between a specific receiving compartment 3, 3′, 3″ and a specific receiver or collector, but the compartment allocation is flexible and mostly random. Thus an automatic storage system 1 with a specific number of receiving compartments 3, 3′, 3″ can take into account a much higher number of potential retrievers or collectors of objects.

The automatic housing 2 is typically supported on a base element 13, which base element 13 is supported on sufficiently solid ground, in particular on a sufficiently supportable standing surface 14. The vertical height 15 of the base element 13 is usually less than about 30 cm, preferably about 15 cm. The usable height 16 of the automatic housing 2 or the compartment arrangement 4 can be up to 200 cm, typically between 150 cm to 180 cm. Within said usable height 16 are a plurality of receiving compartments 3, 3′, 3″ at different height levels, where the number of receiving compartments 3, 3′, 3″ arranged on top of one another is typically between 3 to 15 compartments, preferably about 6 to 12 compartments.

The width 17 of the automatic housing 2 is mainly dependent on the number of receiving compartments 3, 3′, 3″ required at the respective location. Preferably, the automatic housing 2 or the number of receiving compartments 3, 3′, 3″ in the compartment arrangement 4 can be extended and reduced in size by connecting together modular, cupboard-like compartment units depending on the respective requirements. In the exemplary embodiment shown a total of eight cupboard-like compartment modules form the corresponding compartment arrangement 4 with a corresponding number of receiving compartments 3, 3′, 3″, where in this case three different compartment sizes can be provided. The width 17 of the automatic housing 2 can thus vary between 2 and 12 m, where a width 17 of about 5 m is typical or common.

According to the exemplary embodiment shown it is expedient to provide the user interface 8 of the automatic storage system 1 approximately in the middle of the width 17. It is advantageous in particular to provide a cupboard-like control module which contains the user interface 8 and position this cupboard-like control module approximately in the middle of the compartment arrangement 4, which consists of modular-like cupboard bodies, as shown by way of example in FIG. 1. Thus the compartment arrangement 4 comprises a compartment group 18 formed to the left relative to the user interface 8 and a further compartment group 19 arranged to the right of the user interface 8.

As can be seen best from an overview of FIG. 1 and FIG. 2, preferably a plurality of automatic storage systems 1, 1′, 1″ are networked together. In particular, a data network 20 is provided which preferably comprises the internet 21 in order to set up a data communication system 22. The communication system 22 comprises at least one server system 23 with at least one data server 24, which manages at least one database 25.

The data-technical communication system 22 also comprises at least one management system 26, by means of which sequences and configurations can be influenced and services can be provided. For example, the management system 26 can comprise at least one support point 27, at least one service point 28, at least one coordination point 29 and/or at least one management point 30 for managing processes relating to the deliverer.

The server system 23 can also comprise at least one tracking system 31 (track and trace), at least one item management system 32, at least one payment system 33, at least one data exchange system 34 and/or at least one post date management system 35.

Preferably, the users of the represented automatic system 36 are also integrated or can be integrated into the communication system 22. The automatic system 36 consists preferably of a plurality of automatic storage systems 1, 1′, 1″, which are placed in different locations or in different towns or districts, in order to optimize mainly the delivery of postal items to potential recipients.

It is advantageous if a communication system 37 is formed by means of which for retrieving postal items or objects authorized recipients or collectors can be informed spontaneously about postal items or objects deposited temporarily in the automatic system 36. The messaging system 37 can provide collection messages and/or other system-relevant information, for example collection or access codes. These messages are preferably sent or addressed specifically to specific users by integrating an e-mail system 38 and/or a short messaging system 39 (SMS). In this way an authorized recipient or collector can be informed immediately about the storage of a postal item addressed to him in a specific automatic storage system 1.

According to an advantageous development in the data technical communication system 22 at least one internet portal 40 can be implemented. This internet portal 40 can preferably be used by authorized users of the automatic system 36 or communication system 22 in order to influence to a certain extent the processes in the automatic system 36 or download status information. This internet portal 40 can preferably be used via various personal communication devices, for example personal computers, smartphones or handheld-PCs, in particular downloaded and operated, in particular changed via an internet connection.

The control systems 6, 6′, 6″ of the respective automatic storage systems 1, 1′, 1″ of the automatic system 36 are also integrated into the communication system 22, so that it is possible to influence the processes or change and/or read the respective system status or databases of the individual automatic storage systems 1, 1′, 1″.

It is essential that at least some of the aforementioned systems, in particular the control systems 6, 6′, 6″, the server systems 23, the management systems 26, the automatic systems 36 and/or the communication systems 37 are coupled together or can be coupled to one another by means of the at least one communication system 22, in order to be able to perform the necessary data or information exchange, as necessary for the method described below.

In the following a practical method for operating automatic storage systems 1, 1′, 1″ is described for the distribution of objects, in particular goods or postal items, wherein said objects are to be distributed specifically to a plurality of people or transferred individually. The following parts of the description relate for reasons of simplicity to a single automatic storage system 1, but can relate by analogy to the whole automatic system 36, comprising a plurality of automatic storage systems 1, 1′, 1″.

According to this delivery or distribution method the objects to be distributed and transferred to authorized recipients are stored by at least one authorized deliverer, such as for example an employee of a delivery company, in a respective receiving compartment 3, 3′, 3″ of a compartment arrangement 4 of an automatic storage system 1 consisting of several receiving compartments. The deliverer makes his way preferably to an automatic storage system 1 selected by an authorized recipient or an automatic storage system 1 as close as possible to the place of residence or stay or workplace of the recipient. The delivery of the respective postal items or objects is usually performed by means of vehicles, in particular transport vehicles, where a deliverer as a rule separately inserts a plurality of postal items into the various receiving compartments 3, 3′, 3″ of an automatic storage system 1. After insertion the respective object or the respective postal item remains stored temporarily in the corresponding receiving compartment 3, 3′, 3″ until it is collected by an authorized person, in particular by an authorized recipient or collector. At a time determined by the authorized recipient or collector the temporarily stored postal item is collected or picked up, and this time can preferably be selected by the authorized recipient or collector to be at any time of day or night.

As already known, then the respectively deposited objects are released to authorized persons for removal by the control system 6, which is influenced if necessary by the communication system 22 depending on the use or access rights to the respective object or to the respective receiving compartment 3, 3′, 3″. The allocation between the respective postal items or objects and recipients or collectors is thereby specific or individual. This means that a specific object or a specific postal item can only be taken or collected by a specific or authorized person. For this the control system 6 preferably performs a check of the access authorization, for example via access codes and/or access authorization means in the form of data carriers or tickets and/or an identification check of the respective person.

It is essential that in the control system 6, which is preferably a part component of the communication system 22, at least one evaluation system 41 is used or saved relating to the ergonomic and/or person-specific accessibility or reachability of the individual receiving compartments 3, 3′, 3″. This evaluation system 41 takes into account in particular the different accessibility or reachability of the individual receiving compartments 3, 3′, 3″ of the compartment arrangement 4. In particular, due to the collection of receiving compartments 3, 3′, 3″ in the compartment arrangement 4 there are receiving compartments 3, 3′, 3″ with comparatively easy or comfortable accessibility and other receiving compartments 3, 3′, 3″ with comparatively difficult or physically slightly more demanding accessibility for people. The evaluation system 41 characterizes and defines the respective accessibility or reachability of the individual receiving compartments 3, 3′, 3″. With regard to the ergonomic accessibility or reachability of receiving compartments 3, 3′, 3″ many different person-dependent criteria can be considered, such as for example physiological movement restrictions caused by back, shoulder or foot problems and/or the physical shortness of small people and/or the use of the automatic storage systems 6 or automatic system by children. In particular, in the control system 6 or in the communication system 22 an evaluation of the accessibility or reachability of at least a portion of the individual receiving compartments 3, 3′, 3″ of the compartment arrangement 4 can be stored or downloaded.

For this, as shown schematically in FIG. 3, a data-technical allocation of identifiers I, II, III; i, ii about the accessibility or reachability of the individual receiving compartments 3, 3′, 3″ of the compartment arrangement 4 can be stored or retrieved in the control system 6 or in the communication system 22. It is advantageous, if the receiving compartments 3, 3′, 3″ of the compartment arrangement 4 are divided into groups with varying accessibility and these correspondingly grouped or classified receiving compartments 3, 3′, 3″ can be favored or necessarily assigned for use by a specific person requiring particularly good accessibility.

It is also essential in this connection that by means of the control-technical support of the control system 6 or communication system 22 by way of the evaluation system 41 there is prioritized allocation or a preferred use of receiving compartments 3, 3′, 3″, such that objects which are to be collected by people with a known or accepted physical disability or persons with increased comfort requirements are necessarily or preferentially stored in receiving compartments 3, 3′, 3″ of the compartment arrangement 4 which have comparatively easy access for people with a known or accepted physical disability or persons with increased comfort requirements or allow good accessibility to the stored object. These allocations or assignments are implemented on the basis of data-technical evaluations by the control system 6 or by the communication system 22. Mainly process-technical or program-technical implementations in the control or communication system 6, 22 enable the implementation of the respectively described method steps or processing measures.

According to an advantageous measure with regard to the evaluation of the accessibility or reachability of the individual receiving compartments 3, 3′, 3″ it is advantageous to allocate the receiving compartments 3, 3′, 3″ of the compartment arrangement 4 via data technology to at least two different height levels I, II, wherein said height levels I, II define different accessibility classes. It is particularly advantageous to divide the compartment arrangement 4 into at least three height levels I, II, III, whereby the receiving compartments 3, 3′, 3″ of the compartment arrangement 4, which are arranged approximately between the hip and eye level of adult persons, define a first height level I with comparatively easy access or good reachability to stored objects. The receiving compartments 3, 3′, 3″ which are arranged in the bottom or ground section of the compartment arrangement 4 may have worse accessibility or reachability and thus define a different accessibility class via data technology. Furthermore, the receiving compartments 3, 3′, 3′, which are arranged above the comfort height level I, can define a third accessibility class, which compared to the receiving compartments 3, 3′, 3″ within height level I have a slightly more difficult accessibility or reachability.

It is also possible to take into account for the various height levels or accessibility classes of the receiving compartments 3, 3′, 3″ the closeness to the ground, sitting height, normal chest height, head height and the like.

In addition to a height-dependent definition of the accessibility classes it is also possible alternatively or in combination with this to define at least two different, distance-dependent accessibility classes. In particular, it can be an advantage to assign the receiving compartments 3, 3′, 3″ of the compartment arrangement 4, which are arranged in the vicinity of the user interface 8 of the automatic storage system 1, to an immediate area i with relatively easy accessibility or reachability and to classify those receiving compartments 3, 3′, 3″ of the compartment arrangement 4, which lie outside the immediate area i, in at least one lateral or peripheral area ii as having a comparatively large horizontal distance from the user interface 8.

In principle individual accessibility classes or accessibility areas can also overlap partly, i.e. specific receiving compartments 3, 3′, 3″ can belong to more than one accessibility class or accessibility area. Said classes or areas can be characterized in that the assigned receiving compartments 3, 3′, 3″ of persons of average height can be reached comfortably without impairment by wheelchair users, by short or particularly tall people or people with balance problems, problems with the spine or joints. Said classes or areas can also be characterized by guidelines from relevant standards.

It can also be advantageous if an authorized deliverer of objects, in particular a parcel or letter deliverer, is forced by the control system 6 or at least encouraged to deposit the object to be stored in a receiving compartment 3, 3′, 3″ with good accessibility, if the control device 6 recognizes or detects that the authorized recipient of the respective object or the authorized collector of the object has indicated to the control system 6 the need for increased comfort or the existence of physical disabilities, or physical disabilities have been stored in a database 25 accessible by the control system 6.

According to an expedient or advantageous control measure when an authorized deliverer stores an object, which object is then to be transferred to a person with increased comfort requirements or to a person with physical disabilities or a physically impaired collector, the control system 6 automatically opens a free receiving compartment 3, 3′, 3″ of each compartment size within a level I and/or i of the compartment arrangement 4, which has a relatively good accessibility or reachability, and depending on the respective size of the object to be deposited the authorized deliverer fills a receiving compartment 3, 3′, 3″ of sufficient or corresponding compartment size with the object to be deposited. Then the deliverer can manually lock the compartment doors 7, 7′, 7″ and/or the control system 6 can automatically lock the compartment doors 7, 7′, 7″ or a different locking device of the corresponding receiving compartments 3, 3′, 3″ and the stored object can be protected from unauthorized access.

It can also be expedient to configure the control system 6 such that if a receiving compartment 3, 3′, 3″ with the required accessibility or desired reachability is not available in a preferred or favored automatic storage system 1, an authorized deliverer is told to store the object to be deposited in a receiving compartment 3, 3′, 3″ with a different or next best accessibility. For this preferably the output device in the form of a display 12 is used by the control system 6. Alternatively, it is possible that the control system 6 suggests storing in a the next closest or alternatively usable automatic storage system 1′ with a free receiving compartment 3, 3′, 3″ with the correspondingly requested accessibility or desired reachability. By means of data-technical networking or by means of the communication system 22 it is possible to upload such status information and display it or visualize it in a suitable place.

According to an advantageous measure at least some of the people who are authorized to collect and/or retrieve objects are registered in a database 24 accessible by the control system 6. This means that the identity and for example, system-relevant, individual settings and data are collected, in order to perform the respectively described processes and to implement them more quickly and efficiently.

In connection with the method according to the invention it can be advantageous for example to save information in the database 25 about any possible physical disabilities of registered persons, such as for example wheelchair use, shoulder injury, physical shortness, various mobility impairments or similar information about specific movement restrictions caused by another physical handicaps. On the basis of this current data then a technically controlled allocation or assignment of receiving compartments 3, 3′, 3″ can be carried out which provides such people with relatively easy or the best possible accessibility or reachability.

Furthermore, it can be advantageous if the control system 6 is configured or programmed such that people authorized to collect objects or people who have the right to influence the control systems 6 can arrange the preferred or compulsory storage of objects in receiving compartments 3, 3′, 3″ with specific accessibility and/or such an arrangement can be recorded in a database 25 accessible to the control system 6. In particular, it is advantageous if such a registration or request from an authorized user, in particular recipient or collector of objects can be performed via an interne portal 40 which can be uploaded and edited as necessary.

If necessary, the control system 6 can be configured such that a person authorized for the collection and/or retrieval of objects, for which a request for a compartment with relatively good accessibility or reachability has been made or registered in the database 25 of the control system, is charged a fee. In particular, in the case of a comfort-oriented request for receiving compartments 3, 3′, 3″ with easy access, it may be advantageous to charge an increased or a standard end fee for such requirements.

According to an advantageous measure it is also possible to design the control system 6 such that for collectors or retrievers of at least one object registered in the control system 6 the storage of objects in selected receiving compartments 3, 3′, 3″ of a compartment arrangement 4, or in zones of a compartment arrangement 4 with a specific accessibility class in a database 25 accessible by the control system 6, can be released or closed individually. In this way users, in particular the end users of the automatic system 36 can determine if necessary whether the deposit should be made into receiving compartments 3, 3′, 3″ with a specific accessibility class, or whether the storage in a compartment should be random depending on the availability of receiving compartments 3, 3′, 3″.

According to one development the control system 6 can be configured such that in the case of a lock on specific receiving compartments 3, 3′, 3″ or a lock on areas II, III and/or ii with a relatively poor accessibility class, the control system 6 imposes a fee is for the collection and/or for the retrieval of objects on an authorized person. Alternatively or in combination with this, on the opening of specific receiving compartments 3, 3′, 3″ or areas II, III and/or ii with a relatively poor accessibility class, the control system 6 records a benefit for the respective person in the database 25. This benefit can for example be monetary or be in the form of bonus points or entry to prize draws.

According to a further advantageous embodiment the control system 6 can be configured such that during the storage of objects for people that are not recorded in a registration database 25 of the control system 6, so that for these people there is no information or indication in the control system 6 about possible physical disabilities or increased comfort requirements, receiving compartments 3, 3′, 3″ with comparatively good accessibility are allocated automatically, in particular under the assumption that there may be physical restrictions. In this way in a simple manner it is possible to prevent receiving compartments 3, 3′, 3″ with relatively disadvantageous accessibility or reachability being allocated to a recipient or collector who has physical disabilities.

Furthermore, it can be advantageous to configure the control system 6 such that a deliverer entrusted with delivery processes or an authorized deliverer of objects only receives a request to deliver an object into an automatic storage system 1 in a place close to the authorized collector or retriever or into an automatic storage system 1 predetermined by the authorized person, when a receiving compartment 3, 3′, 3″ with suitable accessibility or reachability is available. Failed delivery attempts or journeys without a final possibility of delivery are thus reduced or avoided.

Likewise it can be advantageous to configure the control system 6 such that a receiving compartment corresponding to the required or desired accessibility or reachability is reserved in advance by an authorized deliverer or by a delivery company in a selected automatic storage system 1, before an authorized deliverer makes an attempt to deliver into a corresponding receiving compartment 3, 3′, 3″ of the corresponding automatic storage system 1. Also in this way futile or failed delivery attempts can be avoided or prevented.

According to an advantageous measure information about any physical disability of authorized collectors or retrievers is stored in coded form in a machine-readable identifier on the object to be transferred, in particular on a postal item. The machine-readable identifier can be in the form of a barcode or a transponder or RFID tag, to make it possible to read reliably and quickly and to avoid the necessity of having plain text information. In this way the privacy of people with physical disabilities is protected and in this way specific data protection requirements can be met in a simple manner.

According to an advantageous method step, information about a physical disability of a person who is a designated recipient of a specific object, is read into the control system 6 during the data-technical registration of an object to be delivered to a specific automatic storage system 1 by means of a reading device 11—FIG. 1—by a data-technical identifier on the object, in particular a barcode or RFID tag. On the basis of this information or parameters the control system 6 then causes the allocation of the object to be deposited into a free receiving compartment 3, 3′, 3″ with suitable accessibility or reachability. It is also advantageous to record the objects to be stored, in particular the erection site or other identifier of the automatic storage system 1, 1′, 1″ and to determine the corresponding receiving compartment 3, 3′, 3″ in which the object to be deposited has been finally placed and to utilize the relevant data for future processes.

According to an advantageous measure the control system 6 can also be configured such that a message containing information about the accessibility class of a receiving compartment 3, 3′, 3″, in which an object provided for collection has been stored, is communicated to the person authorized to collect or retrieve the stored object. The messaging system 37—FIG. 2—is used for this, by means of which an e-mail or SMS with the relevant information is sent to the authorized collector or recipient.

According to a further advantageous measure, the control system 6 is configured such that a registered user or person authorized to collect and/or retrieve objects can request the movement of an object already stored in a receiving compartment 3, 3′, 3″ of a different accessibility class. It is advantageous to configure the Internet portal 40 and/or the user interface 8 of the automatic storage system 1, 1′, 1″ such that such a request can be made by an authorized person or entered into the communication system 22.

It can also be advantageous if the corresponding accessibility zone or the position of the receiving compartment 3, 3′, 3″ inside the compartment arrangement 4 is shown to an authorized collector or retriever of a stored object prior to the unlocking of the respective receiving compartment 3, 3′, 3″ on the display 12 of the automatic storage system 1, whereupon the authorized collector or retriever can decide whether the receiving compartment 3, 3′, 3″ should be unlocked by the control system 6, or whether the object should be moved to a receiving compartment 3, 3′, 3″ with better accessibility. In this way unnecessary unlocking procedures at the automatic storage system 1 are prevented so that in some cases difficult, manual or hand locking processes of the corresponding receiving compartments 3, 3′, 3″ by pressing shut the corresponding compartment door 7, 7′, 7″ can become unnecessary.

According to an advantageous embodiment the control system 6 is configured such that an authorized collector or recipient of an object provided for storage is sent an electronic message at a time interval before the deposit in a receiving compartment 3, 3′, 3″ of an automatic storage system 1, 1′, 1″ about the planned storage procedure. This electronic message, for example an SMS or e-mail, preferably comprises a clear identifier relating to the respective, planned storage procedure. In an advantageous manner the authorized collector or recipient can request or demand by means of an electronic communication medium, in particular via an internet portal 40, specifically for the respective storage procedure the storage of the object intended for storage in a receiving compartment 3, 3′, 3″ with the desired or suitable level of accessibility. In this way the flexibility and customer benefit and the utilization of all available receiving compartments 3, 3′, 3″ can be increased further. Accordingly, a message is sent about the impending delivery with a clear identifier for the storage or delivery process to the recipient of a postal item during the delivery of the postal item to an automatic storage system 1, or even during the preparation of an item for transporting to an automatic storage system 1. After that the recipient using an electronic communication device, in particular an internet portal 40, can determine for the respective storage process storage in a compartment with suitable or desirable accessibility which is identified on the basis of the transmitted identifier.

According to practical development a means is provided for checking the authorization, which permits access to information about any possible physical disability of a person registered in the database 25 only by the respectively registered person. In this way the retailer or provider and also the deliverer of goods has no knowledge about any physical disabilities of the recipient or purchaser, whereby personal data is protected effectively from possible misuse. A suitably prioritized allocation of compartments is thus performed as far as possible automatically and discretely independently of interventions or the knowledge status of the provider or deliverer.

The means for checking authorization can in this case be formed by a password protected user account which is accessible via the internet portal 40. In this way the authorized recipient or retriever can save or adapt at any time the relevant requirements in the control system 6 or in the database 25 maintaining full confidentiality.

The exemplary embodiments show possible embodiment variants of the automatic storage system 1, the automatic system 36 and the communication system 22, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

Finally, as a point of formality, it should be noted that for a better understanding of the structures and processes of the communication or automatic system 22, 36, the components thereof have not been represented true to scale in part and/or have been enlarged and/or reduced in size.

The underlying objective of the independent solutions according to the invention can be taken from the description.

Mainly the individual embodiments shown in FIGS. 1, 2, 3 can form the subject matter of independent solutions according to the invention. The objectives and solutions according to the invention relating thereto can be taken from the detailed descriptions of these figures.

### LIST OF REFERENCE NUMERALS

1, 1′, 1″ Automatic storage system
2 Automatic housing
3, 3′, 3″ Receiving compartment
4 Compartment arrangement
5 Access control device
6 Control system
7, 7′, 7″ Compartment door tem
8 User interface
9 Scanning device
10 Entry keyboard
11 Reading device
12 Display
13 Base element
14 Standing surface
15 Height
16 Height
17 Width
18 Compartment group
19 Compartment group
20 Data network
21 Internet
22 Communication system
23 Server system
24 Data server
25 Database
26 Management system
27 Support point
28 Service point
29 Coordination point
30 Management point
31 Consignment tracking
32 Consignment management system
33 Payment system
34 Data exchange system
35 Postal data management system
36 Automatic system
37 Messaging system
38 E-mail system
39 Short messaging system
40 Internet portal
41 Evaluation system
I, II, III Height area
i Close area
ii Lateral or peripheral area

1-24. (canceled)

25. A method for operating automatic storage systems (1) for distributing objects, in particular goods or postal items, to a plurality of persons, where the objects to be distributed and transferred to authorized persons from at least one authorized deliverer are placed respectively in a receiving compartment (3, 3′, 3″) of a compartment arrangement (4) of an automatic storage system (1) consisting of a plurality of receiving compartments (3, 3′, 3″) and are stored temporarily in the corresponding receiving compartment (3, 3′, 3″) until the object is collected by an authorized person, and said objects are released by a control system (6) for removal by an authorized person according to the use or access rights to the respective object or the respective receiving compartment (3, 3′, 3″), where in the control system (6) at least one evaluation system (41) is used for evaluating the physical and/or person-specific accessibility or reachability of the individual receiving compartments (3, 3′, 3″) of the compartment arrangement (4), and an evaluation of the accessibility or reachability of at least a portion of the individual receiving compartments (3, 3′, 3″) of the compartment arrangement (4) or an allocation of identifiers (I, II, III, i, ii) about the accessibility or reachability of the individual receiving compartments (3, 3′, 3″) of the compartment arrangement (4) is stored in or can be downloaded from the control system (6), and by means of the control-technical support of the control system (6) with reference to the evaluation system (41) a prioritized allocation or a preferred use of receiving compartments (3, 3′, 3″) is performed, such that objects which are to be collected by persons with known or accepted, physical disabilities or persons with increased comfort requirements, are stored necessarily or preferably in the receiving compartments (3, 3′, 3″) of the compartment arrangement (4) which are comparatively easily accessible for persons with known or accepted physical disabilities or for persons with increased comfort requirements or enable good accessibility to the stored object, wherein the control system (6) is configured such that for persons who are authorized to collect objects it is possible to arrange the preferred or compulsory storage of objects in receiving compartments (3, 3′, 3″) with specific accessibility can be arranged and such an arrangement is recorded in a database (25) accessible by the control system (6), wherein such a registration or request from an authorized receiver or collector of objects, who is a person with a known or accepted physical disability or a person with increased comfort requirements, can be carried out via an internet portal (40) such that a correspondingly prioritized allocation of a compartment is performed independently of intervention or knowledge of a provider or deliverer of an object as far as possible automatically and discretely.

26. The method as claimed in claim 25, wherein the receiving compartments (3, 3′, 3″) of the compartment arrangement (4) are divided into groups with varying accessability, whereby there is an allocation of the receiving compartments (3, 3′, 3″) into different accessibility classes, which are managed by data and control technology, and said suitably grouped or classified receiving compartments (3, 3′, 3″) can be preferred or necessarily assigned for use by specific persons, who require particularly good access.

27. The method as claimed in claim 26, wherein the control system (6) is configured such that a registered user or recipient of postal items or objects can determine or define as necessary which accessibility classes should be made available or barred for the deposit of objects or postal items.

28. The method as claimed in claim 25, wherein the receiving compartments (3, 3′, 3″) of the compartment arrangement (4) are allocated to at least two different height levels (I, II, III), wherein said height levels (I, II, III) define different accessibility classes.

29. The method as claimed in claim 25, wherein the compartment arrangement (4) is divided into at least three height levels (I, II, III), wherein the receiving compartments (3, 3′, 3″) of the compartment arrangement (4), which are arranged approximately between the hip and eye level of adult persons, define a height level (I) with comparatively easy accessibility or good reachability to stored objects.

30. The method as claimed in claim 25, wherein the receiving compartments (3, 3′, 3″) of the compartment arrangement (4), which are arranged in the vicinity of a user interface (8) of the automatic storage system (1), are assigned by data technology to a close area (i) with relatively easy accessibility or good reachability and the receiving compartments (3, 3′, 3″) of the compartment arrangement (4), which lie outside the close area (i) are classified by data technology into at least one side or peripheral area (ii) at a comparatively greater horizontal distance from the user interface (8).

31. The method as claimed in claim 25, wherein an authorized deliverer of objects is compelled by the control system (6) or at least strongly advised to deposit the object to be stored in a receiving compartment (3, 3′, 3″) with good accessibility, if the control device (6) recognizes that the authorized recipient of the object or the authorized collector of the object has indicated to the control system (6) the need for increased comfort requirements or physical disabilities, or the existence of physical disabilities has been stored in a database (25) of the control system (6).

32. The method as claimed in claim 25, wherein when an authorized deliverer is storing an object which is then to be transferred to a person with increased comfort requirements or to a person with physical disabilities or to a collector with physical disabilities, the control system (6) automatically opens a free receiving compartment (3, 3′, 3″) of each compartment size in an area (I; i) of the compartment arrangement (4), which has relatively good accessibility or reachability, and wherein a receiving compartment (3, 3′, 3″) of sufficient or suitable compartment size is filled with the object to be deposited by the authorized deliverer depending of the respective size of the object to be deposited and then a compartment door (7, 7′, 7″) or other locking device of the corresponding receiving compartment (3, 3′, 3″) is locked.

33. The method as claimed in claim 25, wherein the control system (6) is configured such that if a receiving compartment (3, 3′, 3″) with the required accessibility or desired reachability of a primary or preferred automatic storage system (1) is not available an authorized deliverer is told to store the object to be deposited in a receiving compartment (3, 3′, 3″) with different or next best accessibility, or a suggestion is made to store it in the next closest or alternatively usable automatic storage system (1′, 1″) with a free receiving compartment (3, 3′, 3″) with the suitable accessibility or desired reachability.

34. The method as claimed in claim 25, wherein persons authorized to collect and/or for retrieve objects are registered in a database (25) accessible by the control system (6).

35. The method as claimed in claim 34, wherein information about any possible physical disabilities of registered persons, such as for example about wheelchair users, people with shoulder injuries or short people are stored in the database (25).

36. The method as claimed in claim 25, wherein the control system (6) is configured such that a person authorized to collect and/or retrieve objects, where the said request has been entered or registered in the database (25) of the control system (6), is charged a fee.

37. The method as claimed in claim 25, wherein the control system (6) is configured so that for collectors or recipients of at least one object registered in the control system (6), the storage of objects in selected receiving compartments (3, 3′, 3″) of a compartment arrangement, or in areas of a compartment arrangement (4) with a specific accessibility class in a database (25) accessible by the control system (6) can be individually released or locked.

38. The method as claimed in claim 35, wherein the control system (6) is configured such that if there is a barrier to specific receiving compartments (3, 3′, 3″) or a barrier to areas (II, III; ii) with a relatively poor accessibility class the person authorized to collect and/or retrieve objects is charged a fee by the control system (6), or on the opening of specific receiving compartments (3, 3′, 3″) or areas (II, III; ii) with a relatively poor accessibility class the control system (6) logs a discount for the respective person in the database (25).

39. The method as claimed in claim 25, wherein the control system (6) is configured such that during the storage of objects for persons not recorded in a registration database (25) of the control system (6) where no information or indication about any physical disability is available for these persons in the control system (6), the allocation of receiving compartments (3, 3′, 3″) with comparatively good accessibility is performed automatically, in particular with the assumption that there may be physical disabilities.

40. The method as claimed in claim 25, wherein the control system (6) is configured such that an authorized deliverer only receives a request for the delivery of an object to an automatic storage system (1) located close to the authorized person or to an automatic storage system (1) predefined by the authorized person, as soon as a free receiving compartment (3, 3′, 3″) with suitable accessibility or reachability is available.

41. The method as claimed in claim 25, wherein the control system (6) is configured such that a receiving compartment (3, 3′, 3″) with suitable accessibility or reachability in a selected automatic storage system (1) is reserved in advance by an authorized deliverer or a delivery company, before an attempt is made by the authorized deliverer to deliver to a suitable receiving compartment (3, 3′, 3″) of the corresponding automatic storage system (1).

42. The method as claimed in claim 25, wherein information about any physical disability of the person authorized to receive or collect the object is stored in coded form in a machine-readable identifier on the object to be transferred.

43. The method as claimed in claim 25, wherein information about the physical disability of a person registered to collect a specific object is read into the control system (6) during the data-technical registration of an object to be delivered to a designated automatic storage system (1) by means of a reading device (11) via a data-technical identifier on the object, in particular a barcode or RFID tag, and the control system (6) enforces or supports the allocation of the object to be deposited into a free receiving compartment (3, 3′, 3″) with suitable accessibility or reachability.

44. The method as claimed in claim 25, wherein the control system (6) is configured such that a message containing information about the accessibility class of the receiving compartment (3, 3′, 3′) in which an object for collection has been stored is sent to the person authorized to collect or retrieve the stored object.

45. The method as claimed in claim 25, wherein the control system (6) is configured such that a registered user or person authorized to collect and/or receive objects can arrange for an object already stored in a receiving compartment (3, 3′, 3″) to be moved to a receiving compartment (3, 3′, 3″) in a different accessibility class.

46. The method as claimed in claim 25, wherein the relative accessibility or position of the receiving compartment (3, 3′, 3″) inside the compartment arrangement (4) is shown on a display (12) of the automatic storage system (1) to an authorized collector or retriever of a stored object prior to unlocking the receiving compartment (3, 3′, 3″), and the authorized collector or retriever can decide whether the receiving compartment (3, 3′, 3″) should be unlocked by the control system (6) or whether the object should be moved to a receiving compartment (3, 3′, 3″) with better accessibility.

47. The method as claimed in claim 25, wherein the control system (6) is configured such that an electronic message about the planned storage procedure is transmitted to an authorized collector or retriever of an object for storage at a time prior to storing in a receiving compartment (3, 3′, 3″) of an automatic storage system (1, 1′, 1″), and the authorized collector or retriever can request or arrange via an electronic communication medium, in particular via an internet portal (40), with respect to the respective storage procedure for the object provided for storage to be placed in a receiving compartment (3, 3′, 3″) with a desired or suitable level of accessibility.

48. The method as claimed in claim 25, wherein a means is provided for checking authorization which allows access to information about the possible physical disability of a person registered in the database (25) solely by the respectively registered person.

49. The method as claimed in claim 48, wherein the means for checking the authorization is a password-protected user account accessible via the internet portal (40).

50. An automatic storage system (1, 1′, 1″) for distributing objects, in particular goods or postal items, to a plurality of persons, wherein the objects to be distributed and transferred to authorized persons are stored by at least one authorized deliverer in a receiving compartment (3, 3′, 3″) of a compartment arrangement (4) of an automatic storage system (1, 1′, 1″) consisting of a plurality of receiving compartments (3, 3′, 3″) and are held temporarily until the respective object is collected by an authorized person from a corresponding receiving compartment (3, 3′, 3″), and said objects can be released by a control system (6) depending on the use or access rights to the respective object or to the respective receiving compartment (3, 3′, 3″) to authorized persons for removal, wherein the control system (6, 6′, 6″) is configured for performing and implementing the method as claimed in claim 25.
